(19) United States
(12) Patent Application Publication
(10) Pub. No.: US 2026/0163910 A1
(43) Pub. Date: Jun. 11, 2026

(54) METHOD FOR MANAGING VEHICLE RISK AND SERVER THEREFOR

(71) Applicant: HL MANDO CORPORATION, Gyeonggi-do (KR)

(72) Inventors: Yongwoo LEE, Gyeonggi-do (KR); Hoondow JANG, Gyeonggi-do (KR); Jaehyeon LIM, Gyeonggi-do (KR); Dasol KIM, Gyeonggi-do (KR)

(21) Appl. No.: 19/411,143

(22) Filed: Dec. 5, 2025

(30) Foreign Application Priority Data
Dec. 6, 2024 (KR) 10-2024-0180767
Dec. 1, 2025 (KR) 10-2025-0187545

(51) Int. Cl. H04L 9/40

(52) U.S. Cl. CPC H04L 63/1433

(57) ABSTRACT

In a vehicle risk management method performed by a server, the method may comprise, identifying a predicted threat scenario by analyzing a plurality of asset elements of the vehicle, deriving an impact scenario according to the predicted threat scenario and deriving an attack path based on the impact scenario, and establishing a security goal of the vehicle based on the attack path and the predicted threat scenario.

### CROSS-REFERENCE TO RELATED APPLICATION

This application claims the benefit of Korean Patent Application Nos. 10-2024-0180767, filed on Dec. 6, 2024 and 10-2025-0187545, filed on Dec. 1, 2025 in the Korean Intellectual Property Office, the disclosure of which is incorporated herein by reference.

### BACKGROUND

### 1. Field

The disclosed invention relates to a vehicle risk management method and a server for performing the same.

### 2. Description of the Related Art

Among the various fields of the automobile industry, the most innovative and rapidly developing area since the 2000s has been the field of electrical and electronic systems. In particular, controllers that govern vehicle behavior have significantly contributed to road traffic safety by providing drivers with a more stable driving experience through more precise control enabled by advancements in vehicle semiconductors and embedded software. In addition, by offering convenience features for drivers, the marketability of vehicles has been further enhanced. Going beyond controlling engines or brakes, vehicles now provide smart keys, navigation systems, and various infotainment systems. Accordingly, multiple controllers in a vehicle communicate and exchange information with each other through the in-vehicle network.

Along with these advancements, the complexity of vehicle systems and the importance of safety continue to increase, but high-risk accidents caused by compound failures of electrical and electronic components intended to ensure software invisibility and availability are still being continuously reported.

Meanwhile, with the increased robustness of individual vehicle controllers and advancements in communication technologies, cooperative control among in-vehicle controllers has rapidly progressed, and as infotainment systems have also advanced, the exposure of assets to potential threats has increased.

To prevent such threats, the cybersecurity standard ISO/SAE 21434 was setted. ISO/SAE 21434 was structured closely to ISO 26262, one of the successful precedents, which significantly contributed to its rapid adoption.

ISO/SAE 21434 is an international standard that deals with vehicle cybersecurity, defining security requirements and development processes aimed at protecting a vehicle's electronic systems from external attacks.

ISO/SAE 21434 requires a comprehensive cybersecurity management framework that includes vehicle security threat analysis, risk assessment, security design, and the settment of response plans. For example, ISO/SAE 21434 requires the identification and assessment of threats at the level of the vehicle and its components, such as systems, software, and hardware (also referred to as items), in order to respond to external cyberattacks. In other words, it requires the execution of Threat Analysis and Risk Assessment (TARA).

With the settment of these standards, compliance with them has become an essential requirement throughout the automotive industry. Accordingly, companies manage functional safety and cybersecurity activities separately to perform the specialized tasks required by each standard.

In particular, for cybersecurity, some companies have dedicated departments to respond quickly to newly setted European regulations. Furthermore, the distribution of requirements for vehicle development is carried out by different parties at different points in time.

Since ISO 26262 and ISO/SAE 21434 differ in their requirements and approaches, companies traditionally manage HARA and TARA separately to perform specialized work for each international standard.

Although an increasing number of companies are developing and commercializing software tools specialized for TARA, the majority still create and manage TARA using Excel-based forms.

Meanwhile, independently from TARA, the preparation of a Fail-Safe Management (FSM) document for a vehicle is often required according to the needs of an enterprise or its customers. The FSM document is a material that organizes detection and reaction strategies for various failures of the product, and summarizes aspects related to elements that may affect the product, such as failures of item elements and failures of external interfaces.

### SUMMARY

The problem to be solved by the present invention is to provide a vehicle risk management method and a server for the same that can integrate threat analysis and risk assessment (TARA; Threat Analysis and Risk Assessment), fail-safe management (FSM; Fail-Safe Management), and fundamental information of the vehicle system, including interfaces and architectures of a project.

The problem to be solved by the present invention is to provide a vehicle risk management method and a server for the same that provide a software tool supporting the execution of the TARA procedure.

The problem to be solved by the present invention is to provide a vehicle risk management method and a server for the same that improve the integrated management and reusability of data generated and used during the TARA analysis process, and manage common data required for security threat analysis in a standardized format.

The problem to be solved by the present invention is to provide a vehicle risk management method and a server for the same that automatically output TARA results as various types of reports or documents depending on their intended purpose.

The problem to be solved by the present invention is to provide a vehicle risk management method and a server for the same that can output results in a format required by an OEM for DTC (Diagnostic Trouble Code) related analysis, such as GMRDB, or in an OEM-specific TARA template, based on an integrated database.

According to one aspect of the disclosed invention, a vehicle risk management method may include analyzing a plurality of asset elements of the vehicle to identify a predicted threat scenario, deriving an impact scenario corresponding to the predicted threat scenario and deriving an attack path based on the impact scenario, and establishing a security goal of the vehicle based on the attack path and the predicted threat scenario.

The plurality of asset elements may include an asset to be protected, a function of the asset, and a property of the asset, and the function of the asset corresponds to the function of the vehicle, and a safety hazard caused by a malfunction of the function of the vehicle corresponds to a security risk caused by a compromise of the function of the asset.

The impact scenario may be generated by deriving a damage scenario according to the plurality of asset elements and simulating an influence of the damage scenario on a driver or the vehicle.

The attack path may be determined based on an impact rating determined according to at least one of a safety element, a financial element, an operational element, and a privacy element for the impact scenario.

The safety element may be derived from a safety level, and the safety level may be determined by evaluating exposure, severity, and controllability of the hazard situation according to a predetermined evaluation criterion and combining the evaluation results of the exposure, the severity, and the controllability.

The security goal may be generated based on a risk value according to the attack path and the predicted threat scenario.

Based on the security goal, a security control measure and an alternative security measure for satisfying a condition of a safe state may be determined.

The method may further include setting diagnostic control logic to achieve the security goal of the vehicle, wherein setting the diagnostic control logic comprises, defining a security threat condition of the vehicle and setting parameters used to determine the security threat, the parameters being stored in a database, and deriving diagnostic information and response-related information associated with the security threat of the vehicle based on the parameters, and storing the diagnostic information and the response-related information in the database for use as threat evaluation input data.

For the same or similar predicted threat scenario, results of applying the diagnostic control logic are matched with each other to be linked or managed in the database.

As a technical means for achieving the aforementioned technical objectives, a computer program according to an aspect of the present invention may be stored in a medium so that the program can be executed by a computing device to perform the above-described vehicle risk management method.

A server according to an aspect of the disclosed invention may include a database configured to store a plurality of data for vehicle risk management, a communication module configured to communicate with an external device, and a processor electrically or communicatively connected to the database and the communication module, wherein the processor is configured to analyze a plurality of asset elements of the vehicle to identify a predicted threat scenario, derive an impact scenario according to the predicted threat scenario and derive an attack path based on the impact scenario, and establish a security goal of the vehicle based on the attack path and the predicted threat scenario.

The plurality of asset elements may include an asset to be protected, a function of the asset, and a property of the asset, and the function of the asset may correspond to a function of the vehicle, and a safety hazard caused by a malfunction of the function of the vehicle may correspond to a security risk caused by the compromise of the function of the asset.

The impact scenario may be generated by deriving a damage scenario according to the plurality of asset elements and simulating an influence of the damage scenario on a driver or the vehicle.

The attack path may be determined according to an impact rating determined based on at least one of a safety element, a financial element, an operational element, and a privacy element for the impact scenario.

The safety element may be derived from a safety level, and the safety level may be determined by evaluating exposure, severity, and controllability of a hazard situation according to predetermined assessment criteria and combining results of the evaluation of the exposure, the severity, and the controllability.

The security goal may be generated based on a risk value according to the attack path and the predicted threat scenario.

The processor may be configured to determine security control measures and alternative security measures to satisfy a condition of a safe state based on the security goal.

The processor may be configured to set diagnostic control logic to achieve the security goal of the vehicle, define a security threat condition of the vehicle, set parameters used to determine the security threat, and store the parameters in the database, and derive diagnostic information and response-related information associated with the security threat of the vehicle based on the parameters and store the diagnostic information and the response-related information in the database for use as threat evaluation input data, thereby setting the diagnostic control logic.

The processor may be configured such that, for the same or similar predicted threat scenarios, results of applying the diagnostic control logic are matched with each other to be linked or managed in the database.

It is an objective of certain embodiments of the present invention to address, alleviate, or at least partially resolve at least one of the problems and/or disadvantages associated with the related art. Certain embodiments are intended to provide at least one of the advantages described below.

According to one aspect of the disclosed invention, a vehicle risk management method and a server for the same perform a threat analysis and risk assessment (TARA; Threat Analysis and Risk Assessment) procedure, thereby enabling security-related risks to be managed in a more systematic and efficient manner.

In addition, according to the present invention, a software tool supporting the execution of the TARA procedure automates a series of processes including threat identification, hazardous event derivation, security goal settment, and risk level determination. Furthermore, by utilizing fundamental information such as DTC information and the vehicle architecture together, consistency and reliability of the TARA results can be ensured.

According to the present invention, the common data generated during the TARA process is managed in a standardized integrated database format, which improves the reusability and traceability of the data required for security threat analysis.

According to the present invention, TARA result data can be output in various templates depending on the intended purpose, thereby enabling the generation of result reports that include security goals, hazardous events, and safety mechanisms.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a diagram illustrating a system for vehicle risk management according to an embodiment;

FIG. 2 is a diagram illustrating a stepwise analysis procedure and relational diagram of security threats according to an embodiment;

FIG. 3 is a diagram exemplifying security threat data according to the embodiment of FIG. 2;

FIG. 4 is a block diagram of a vehicle risk management system according to an embodiment;

FIG. 5 is a flowchart illustrating a control operation procedure of a server according to an embodiment; and

FIG. 6 is a flowchart illustrating a control procedure of a server for achieving a security goal of a vehicle according to an embodiment.

### DETAILED DESCRIPTION

Throughout the specification, the same reference numerals refer to the same components. The specification does not describe every element of the embodiments, and general or overlapping content within the technical field of the disclosed invention is omitted. The terms “unit, module, member, block” used in the specification may be implemented in software or hardware. Depending on the embodiments, multiple “units, modules, members, blocks” may be implemented as a single component, or one “unit, module, member, block” may include multiple components.

Throughout the specification, when a part is described as being “connected” to another part, this includes not only cases where they are directly connected but also cases where they are indirectly connected, and indirect connection includes connection via a wireless communication network.

In addition, when a part is described as “including” an element, this means that, unless explicitly stated otherwise, the part may include additional elements rather than excluding other elements.

Throughout the specification, when a member is described as being “on” another member, this includes not only cases where the member is in contact with the other member but also cases where another member is interposed between the two.

The terms first, second, and so forth are used solely to distinguish one component from another and do not limit the components by these terms.

Singular expressions include plural forms unless the context clearly indicates otherwise.

Reference numerals for steps are used for convenience of description and do not indicate the order of the steps. Unless the context explicitly requires a particular sequence, the steps may be performed in an order different from that described.

TARA primarily analyzes cyber-security threats, focusing on attack paths and external interfaces, whereas HARA focuses on system functional malfunctions and their implications for safety.

The key deliverable commonly required as a preliminary activity in both TARA and HARA is the item definition. This deliverable defines the functional and physical characteristics of the system under analysis and the boundary conditions of the vehicle system, and it can be utilized as essential foundational information for performing TARA and HARA.

The primary components of the item definition may include a definition of the boundaries of the item, the operational environment, regulatory requirements, and the functional description of the item.

Clearly defining the boundaries and interfaces of the vehicle system is critical for both TARA and HARA. This is necessary to determine the scope within which functional malfunctions may have an impact, and to accurately understand how external factors may affect the vehicle system. In particular, it is essential for evaluating how interactions between vehicle systems affect overall safety and security.

To achieve this, the likelihood of attack for each possible attack path must be assessed, and all external interfaces must be thoroughly identified. It is especially important to clearly define the purpose and type of each interface, as a lack of understanding of the information flow related to communication or control processing components makes it difficult to assess the severity and priority of threats. In both TARA and HARA, identifying system boundaries and interfaces is a core task commonly required to comprehensively evaluate system security and safety.

In addition, the various operating modes of a system and its environmental conditions significantly influence both the likelihood and severity of potential hazardous situations. For example, the risk factors during high-speed driving may differ from those during low-speed driving, and vehicle operation under certain environmental conditions, such as severe weather, may introduce additional hazards. Therefore, it is important to identify all possible operating modes and environmental conditions of the vehicle and thoroughly understand how the system behaves in each scenario. This provides essential information for evaluating exposure frequency and controllability.

In practice, the functions manifested by an item may differ depending on its operating environment and operating situation. During this process, the item may also be exposed to various cybersecurity threats that can arise from communication between controllers or from connectivity with external systems. For instance, during certain operating modes or circumstances in the vehicle's life cycle, access to or manipulation of specific information may be restricted, and as a result, the likelihood of threats may vary. Some modes may only be active for short periods, whereas features such as FOTA (Firmware Over the Air) occur periodically but may not be vulnerable to real-time threats. Therefore, the critical information and communication channels for each operating mode must be identified before conducting TARA, as this is an essential preparatory activity for ensuring system security and safety.

TARA analyzes malicious threats that may arise from intentional attacks. Accordingly, TARA evaluates the threats that may occur when the system is intentionally manipulated or attacked and focuses on setting appropriate security countermeasures.

The functional description applicable to TARA within the item definition can serve as important foundational information for systematically identifying potential threats and setting corresponding security goals.

Additionally, TARA has limitations in that identifying assets and understanding data flows based solely on the preliminary architecture level is difficult. Assets that rely on software are challenging to identify internally, and without a clear understanding of data flows, the importance of threats cannot be accurately evaluated. To address this, external interfaces and communication paths must be clearly identified, and defense-in-depth principles should be applied.

In practice, TARA faces significant limitations in identifying assets at the preliminary architecture stage. This is due to the fact that cybersecurity assets rely heavily on software, and it is particularly difficult to identify assets such as specific encryption algorithms or cryptographic keys.

For example, when item is part of a vehicle black box, there may be limitations in identifying internal assets aside from interfaces with external elements. This results in constraints during the asset-derivation process and necessitates more detailed system information. Additionally, TARA may face limitations in assessing the importance of threats when data flows are not clearly identified.

If data flows are not clearly defined, it becomes difficult to evaluate the significance of threats. TARA requires assessing the likelihood of attacks for each possible attack path, and for this purpose, identifying all external interfaces and clearly defining the purpose and type of each interface is essential. Without identifying communication paths and control-processing routes, the severity and importance of threats cannot be accurately evaluated.

Furthermore, TARA must also consider the hierarchy of communication signals when a single signal affects multiple functions, as accurate assessment is not possible otherwise. Therefore, following the principles of defense in depth, it is necessary to clearly identify the location of controllers within each layer of the vehicle network, which enables the implementation of effective cybersecurity controls at the vehicle level.

Cybersecurity control functions are introduced through TARA as measures to reduce risks associated with certain assets and are often applied as new functions. Therefore, based on the functions defined in the item definition document, hazardous events that may occur if such functions malfunction must be derived.

This process requires recursive analysis, where it becomes important to analyze vehicle behavior and associated risks in the event that a cybersecurity function fails and to identify the resulting events.

Meanwhile, the impact assessment or damage scenarios performed in TARA are closely related to the malfunctions and hazardous events identified in HARA, as well as the severity propertys used to evaluate them. To ensure that these relationships can be assessed as common product properties, the need has emerged to establish a consistent evaluation framework between the two methodologies through a unified system.

Failures caused by attacks ultimately lead to hazardous events, and based on this interrelationship, a unified evaluation method using a single integrated database has been required. This enables consistent risk assessment within the system and is essential for effectively linking the results of each analysis methodology.

Furthermore, considering functional safety propertys such as systematic faults or random hardware failures during threat analysis and preventing malicious attacks by hackers during hazard analysis ultimately converge on the same purpose of preventing system failures.

Hereinafter, the operational principles and embodiments of the disclosed invention will be described with reference to the accompanying drawings.

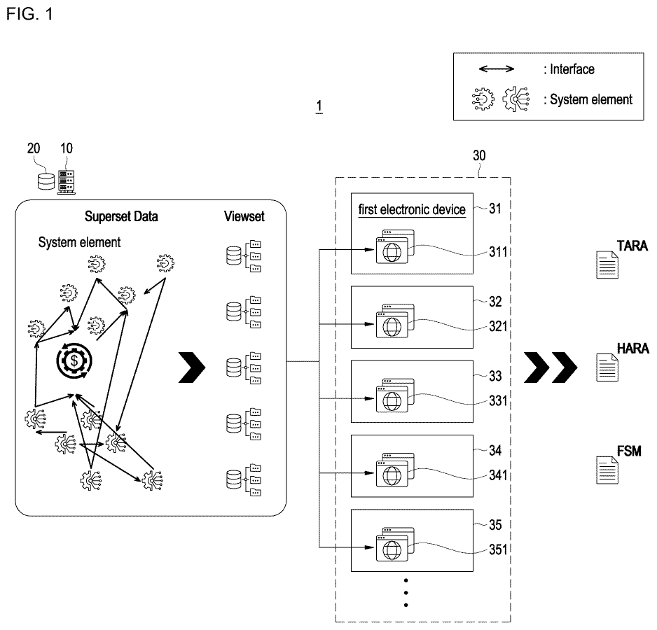

FIG. 1 is a diagram illustrating a system for vehicle risk management according to an embodiment.

Referring to FIG. 1, the vehicle risk management system 1 may include a server 10 and one or more clients 30, for example, first through fifth electronic devices 31, 32, 33, 34, and 35.

The server 10 may provide a web-based service that enables consistent evaluation of common areas by integrally managing TARA, and FSM documents.

The server 10 may store pre-designated and registered assets, functions, system elements of a vehicle, and interface information (also referred to as connection information).

The server 10 may include a database 20, and the database 20 may store assets, functions, system elements of the vehicle, and interface information.

The assets may be one or more and may include hardware and software configurations of the vehicle. They may be additionally registered or deleted. For example, the assets may include vehicle data assets, communication assets, control assets, hardware assets, software assets, authentication and security assets, and user interface assets.

The functions may be one or more and may represent the services provided to the user by the vehicle or its configuration (hardware and/or software).

The system elements may be one or more and may include hardware and/or software components of the vehicle.

The interface information may include information representing the connection relationships between the vehicle's assets and/or functions and the system elements.

The server 10 may structure text-based data and interconnect each piece of data (also referred to as information), and may organize the relationships and structured information of the interconnected data into viewsets. The server may then transmit the resulting data to electronic devices 31, 32, 33, 34, and 35.

For example, the server 10 may structure each text-based data item regarding assets, functions, and/or system elements and may organize the relationships and structured information of each text-based data into a viewset based on interface information, then transmit it to electronic devices 31, 32, 33, 34, and 35.

In response to information (also referred to as data) received from electronic devices 31, 32, 33, 34, and 35, the server 10 may generate and output TARA, and/or FSM output data based on the assets, functions, system elements, and/or interface information.

For example, when the server 10 receives asset information or function information and additional user input data (also referred to as user input information) from an electronic device 31, 32, 33, 34, or 35 that has received the data provided by the viewset, the server may generate TARA, and/or FSM output data corresponding to the relevant asset or function and transmit the generated output data to that electronic device.

TARA evaluates cybersecurity for a vehicle, more specifically the threats and risks within the vehicle. It may analyze these by considering the functions of the relevant components within the vehicle (for example, the controller involved) and/or signals (for example, CAN signals).

For example, TARA may identify impact related to financial loss, safety issues that may cause vehicle accidents and/or occupant injury, operational disruptions that may affect vehicle operation and/or functionality, and privacy risks involving personal data leakage and/or compromise.

Among the threat factors in TARA, the safety-related factors may be analyzed with reference to the hazardous events identified in HARA.

The ultimate purpose of TARA is to identify security goals for the threats identified in the system and derive security control techniques that can mitigate them.

An FSM document organizes the detection and reaction strategies for various product failures and describes the elements that may affect the product, such as failures of data elements or failures of external interfaces.

The FSM document may include information related to safety mechanisms derived from the cybersecurity controls identified through TARA.

There may be common areas shared between the TARA documentation and the FSM documentation, as well as areas that are specialized for each of them.

Meanwhile, the server 10 may have the following conditions predesignated and stored regarding data usage, thereby ensuring the integrity of working data.

### <Conditions>

1. General users among the predefined users cannot enter data.
2 General users cannot write any data other than the data already entered.
3. Only a master user with write permission can enter data.

The server 10 may store data-connection information in advance. Accordingly, when specific information is selected by an electronic device 31, 32, 33, 34, or 35, the connected information may automatically be provided and displayed on that electronic device. Alternatively, all propertys of the table linked to the selected information may be provided and displayed on the electronic device 31, 32, 33, 34, or 35, and the user of that electronic device may directly select the propertys.

Additionally, the server 10 may store information requiring calculation and formulas predesignated to be associated with such information. For information requiring calculation, the server may automatically compute the result using the stored formulas and provide and display the result on the electronic devices 31, 32, 33, 34, and 35.

The server 10 may provide an approval service.

For example, the server 10 may provide an approval service to confirm that finalized information has no further changes after review and inspection between a general user and a master user.

Once the approval process is completed, the corresponding information (for example, an approved viewset) cannot be modified. If changes are needed, an approval request to unlock the data must be submitted.

The server 10 may provide a mailing service.

As a notification function, a mailing service for at least one piece of information may be predesignated in the server 10, and the server may provide the mailing service through communication with a predesignated mail server.

The server 10 may perform data visualization. The server 10 may visualize analytical information such as functional analysis and fault analysis through a structure tree and provide it to the electronic devices 31, 32, 33, 34, and 35.

The server 10 may set and store different user permissions for each user.

For example, the users may include administrators, master users, general users, and associate users. Each user may be distinguished by a user ID (Identifier).

The administrator may have permissions enabling the execution of all possible user activities. For example, the administrator may be able to register or delete users, modify user permissions, and manage data modification. The administrator may also input, edit, and delete bulk data from the administrator page. In addition, the administrator may perform a rollback operation, which cancels ongoing transactions and restores modified data to its original state. The administrator may also modify the dashboard that appears as the first screen upon login.

A master user may have permissions set to allow reading or modifying data within the assigned project. Depending on the project, the master user's data viewing or editing rights may be restricted, and delete permissions may not be granted. The master user may also be granted separate permissions to review viewsets created by general users.

A general user may have permissions to view and modify data within the assigned project. However, in projects where permissions are not granted, the general user's ability to view or modify data may be restricted, and delete permissions may not be granted. The general user may also be given separate permissions to review viewsets created by the master user.

An associate user may have permissions limited to reading and exporting viewsets. For example, the associate user may be permitted only to read and export viewsets and may not perform any other functions.

For example, the server 10 may set and store a predefined permission configuration for each user type, as shown in Table 1.

TABLE 1

| User Type | User Permissions |
|---|---|
| Administrator | Read, Write, Modify, Clear, Import, |
| | Export, Submit, and Approval |
| Master User | Read, Modify (limited to the master database), |
| | Export, and Approval |
| General User | Read, Modify, Export, and Approval |
| Associate User | Read and Export |

In Table 1, “Read” means that the user can read data from projects for which permissions have been granted.

“Write” means that the user can add new entries to the data of a project for which write permission has been granted. However, according to the predefined settings, data may be added only to the “Superset.”

“Modify” means that the user can change existing data in a project for which modification permission has been granted. For example, the user may select and change data through a dropdown box among the graphical user interface (GUI) elements displayed on the screen of the electronic devices 31, 32, 33, 34, and 35.

“Clear” means that the user can delete data, including cases where data inside a Superset project is deleted.

Import” means that data can be loaded into the Superset project through a file in a predefined format, such as an Excel file or a CSV file.

“Export” means that the contents of a viewset of a project for which permission has been granted can be output or saved in a predefined format, such as Excel, Word, or PDF.

“Submit” means that, after completing the evaluation for TARA, the user may submit the corresponding viewset to request approval. For example, when a Functional Safety activity is completed, the viewset for that activity may be submitted for approval.

“Approval” means that the evaluated TARA viewset can be reviewed and approved.

Each of the electronic devices 31, 32, 33, 34, and 35 may receive web-based services from the server 10. A web browser 311, 321, 331, 341, and 351 may be installed on each electronic device, and through the respective web browser, the user may access and use the web-based services of the server 10.

Each of the first to fifth electronic devices (31, 32, 33, 34, 35) may receive TARA and/or FSM output data related to the asset or function of the vehicle from the server and may display the data on a screen or output the TARA and/or FSM as output data.

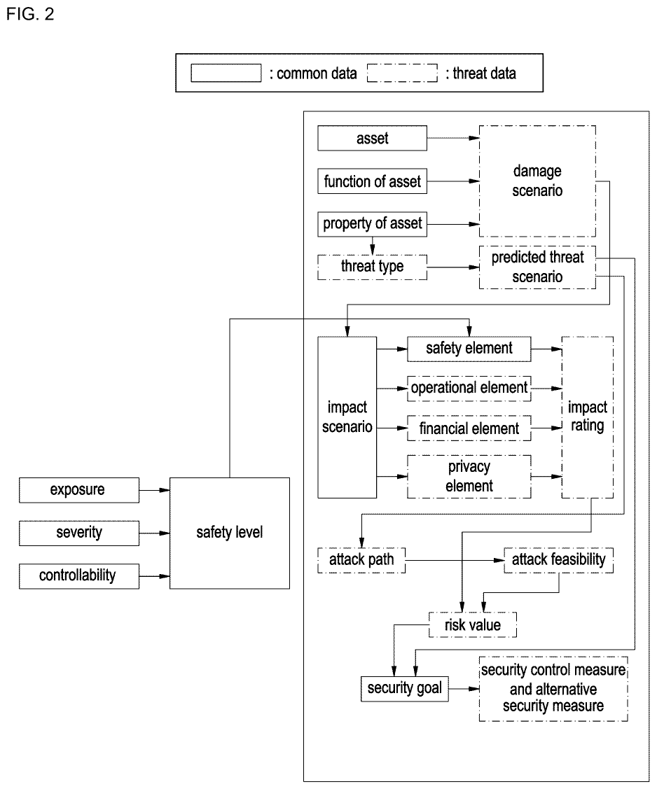

The respective steps of TARA according to an embodiment of the present invention are interrelated, as shown in FIG. 2, enabling the vehicle system to consider both safety and security simultaneously.

TARA also includes a procedure that evaluates each piece of information and/or data by focusing on the respective information and/or data based on the interlinked information and/or data.

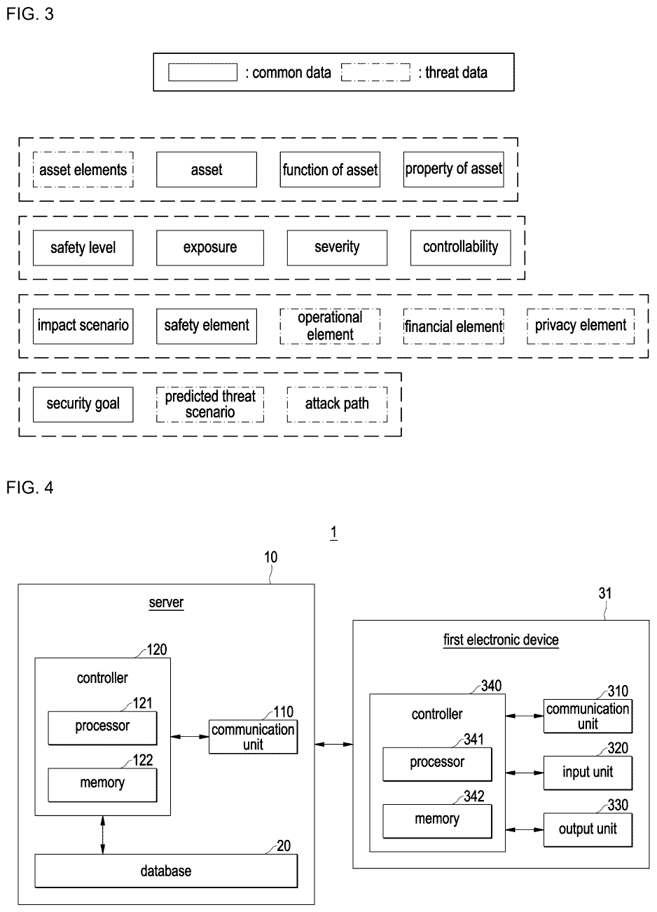

Further, as shown in FIGS. 2 and 3, TARA may be classified into common information and/or data shared between HARA and TARA that can be standardized or generalized, and TARA-specific information and/or data that is tailored for TARA, which may be predefined.

FIG. 2 is a diagram illustrating a stepwise analysis procedure and relational diagram of security threats according to an embodiment.

As illustrated in FIG. 2, a vehicle risk analysis procedure according to an embodiment includes a data flow structure for establishing a security goal based on the analysis results of the vehicle cybersecurity TARA (Threat Analysis and Risk Assessment).

The data flow shown in FIG. 2 may represent the TARA cybersecurity analysis procedure, and the illustrated data analysis flow may be classified into common data and threat data, which may form reference and linkage relationships with one another.

The data related to the plurality of asset elements, that is, the asset to be protected, the function of the asset, and the property of the asset, may be defined as common data that are commonly referenced in both HARA and TARA. In this case, the function of the asset corresponds to the functionality of the vehicle, and the safety hazard caused by a malfunction of a vehicle function may be evaluated in association with the security risk caused by a compromise of the asset functionality.

Specifically, each asset element may include the following items.

The asset may be a physical or logical component within the system that requires protection, such as information including vehicle diagnostic data or control signals. The function of the asset may be an operation performed by the asset or a service provided by the asset, such as reading or writing vehicle diagnostic data. The property of the asset may be characteristic information such as the communication interface to which the asset belongs, the direction of data flow, or the level of access authorization. For example, the property may be defined as “transmitting data to an external device through an internal communication network.”

The asset element data as described above may be used as input information for evaluating the cybersecurity properties of an asset from the perspective of TARA. For example, the security attributes of an asset may be defined as at least one of confidentiality, integrity, availability, non repudiation, and authentication, and the security properties that require protection may vary depending on the characteristics of each asset.

For instance, for certain data services within the vehicle, such as the function of reading vehicle diagnostic data, the data may be accessible by an external device, and therefore confidentiality may be designated as the primary security property to prevent information leakage. Through such analysis, the system may define potential damage scenarios, such as “information leakage,” based on the property information of the asset and sett corresponding security measures.

Meanwhile, the data related to the asset elements may be commonly referenced not only in TARA but also in HARA. For example, while the “read data request function” of the vehicle may be analyzed as a security risk factor related to external access in TARA, the same function may be evaluated as a malfunction in HARA that may pose a safety hazard to the system. Therefore, even when referring to the same asset, depending on its functionality and property, it may be analyzed as an interrelated risk factor from both safety and security perspectives.

According to an embodiment, the system may identify predicted threat scenario by analyzing the plurality of asset elements. In other words, by analyzing information about the various asset components within the vehicle, the system may identify situations that could lead to security vulnerabilities or external attacks in advance. For example, when an internal diagnostic data processing function of the vehicle is defined as a “Read Data” functionality and the function is structured to transmit data to an external diagnostic device through the in-vehicle communication network, the system may evaluate whether there is a risk of data leakage in this process. For instance, if the security of the function is insufficiently reinforced or if authentication procedures are missing along the communication path, there may be a possibility that an external entity could access the in-vehicle data without authorization. Accordingly, the system may identify such a case as an information-leakage-type predicted threat scenario.

In addition, the system may analyze the relationships among multiple assets to derive new threat scenarios through the interconnected functions or data flows. For example, when one asset performs a “data request” function and another asset performs a “data response” function, the system may recognize potential attacks such as message modification, spoofing, or replay within the communication section between the two assets as new threat scenarios.

Here, the predicted threat scenario may be derived based on a threat type. For example, the threat type may be one of spoofing, tampering, repudiation, information disclosure, denial of service, and elevation of privilege. However, these examples are merely illustrative and are not intended to be limiting.

As such, the system of the present invention may automatically derive predicted threat scenario at the system level by analyzing the relationships among the functionalities, communication paths, and cybersecurity properties of the plurality of asset elements, beginning from asset-level damage scenarios.

As another example, when the predicted threat scenario is “information leakage caused by a loss of confidentiality of the diagnostic data request function (ReadData service),” the system may define an impact scenario such as “a situation in which internal diagnostic data or configuration information of the vehicle may be exposed externally, leading to a security breach.” In this case, the threat type may be classified as “information leakage,” and the extent of confidentiality loss may serve as a key evaluation factor for the corresponding impact scenario.

Based on the derived impact scenario, the system may classify the degree to which each hazard or threat affects the overall system. In addition, the impact scenario may be used as common data linking the results of hazard analysis (HARA) and the results of threat analysis (TARA). That is, by integrating the safety-related impact derived from the target hazard scenario and the security-related impact derived from the predicted threat scenario into a single impact scenario dataset, the system may comprehensively analyze the mutual influence between safety and security. In this manner, the system of the present invention may predict the impacts that may arise from situations respectively derived from hazards and threats and may store the corresponding analysis results in the database.

More specifically, the system may analyze the role, behavior path, and interrelationships of each functional element by referring to the target hazard scenario data stored in the database. For example, although the “acceleration request” function of the vehicle normally operates to request an appropriate level of driving torque based on the driver's pedal input, when a malfunction occurs in this function, the system may detect the abnormal condition in which “an excessive acceleration torque beyond the requested level is being demanded.”

When the system detects such a functional malfunction, the system may evaluate the hazardous event that may occur due to the malfunction. For example, when an excessive acceleration request causes the vehicle to move forward regardless of the driver's intention, the system may define this condition as a hazardous event of “unintended longitudinal acceleration of the vehicle.” Thereafter, the system may analyze, through simulation, the influence that the hazardous event may have on the driver and the vehicle. For instance, by inputting variables such as vehicle speed, road conditions, distance to the preceding vehicle, and driver reaction time, the system may evaluate the outcomes that the hazardous event may produce in actual driving environments.

Through such simulation, results such as “the vehicle moving forward in an uncontrollable state,” “increased probability of collision due to a reduction in distance to the preceding vehicle,” and “inability to avoid a collision within the driver's steering or braking reaction time” may be derived. The system may comprehensively analyze the simulation results to determine the influence of the hazardous event on driver safety, vehicle control stability, and occupant protection level, and may define such results as the impact scenario.

According to one embodiment, an attack path may be generated based on at least one of a safety element, financial element, operational element, and privacy element for the impact scenario. Specifically, the system may analyze the data included in the impact scenario to identify a route through which a specific threat may infiltrate and propagate within the vehicle system, and derive a corresponding attack path. For example, when the impact scenario corresponds to “information leakage caused by the loss of data confidentiality in an in-vehicle network,” the system may analyze the connectivity structure of the vehicle assets to derive possible routes through which an attacker may gain access via an external device such as a diagnostic tool, communication module, or gateway.

The generation of such an attack path may be performed from various perspectives depending on the characteristics of the impact scenario. For instance, from the perspective of a safety element, an attack or threat may be evaluated in terms of its impact on safety-related functions such as driving stability, braking systems, and steering systems, and a route through which such functions may malfunction or be tampered with may be defined. For example, when a specific ECU is compromised and a brake control signal is altered, a sequence of intrusion steps may be identified as one attack path.

According to an embodiment, the safety element may be derived from the safety level. That is, the system may determine the level of safety assurance required for each function within the vehicle system based on a safety level determined by evaluating exposure, severity, and controllability according to predetermined assessment criteria. For example, when a function has a high safety level, its malfunction is more likely to directly affect driver safety or vehicle control, and the system may identify such a function as a major safety element and configure additional protective measures to be applied to the system that includes the function.

The financial element is an element that considers the possibility of economic loss resulting from an attack or threat. For example, pathways by which paid communication service data, over-the-air (OTA) update information, or vehicle payment systems may be compromised may be defined as financial elements.

The operational element represents pathways through which functions may be interrupted or may operate abnormally during the operation of the vehicle or the provision of vehicle services. For instance, when access through a remote control system or diagnostic equipment for maintenance is blocked or restricted, the system may identify such cases as attack paths corresponding to operational disruption.

Privacy element is an element that defines pathways through which sensitive information stored in the vehicle, such as driver data, passenger information, or driving history, may be leaked externally. For example, a situation in which vehicle log data may be transmitted without authorization through an external communication module may be evaluated as an attack path that includes a privacy element.

Each of the above elements may be evaluated independently or may be combined to form a composite attack path. For example, a composite attack path involving both privacy leakage and operational disruption may be defined as a path in which an external attacker exfiltrates diagnostic data through a vehicle communication interface while simultaneously disabling communication functions, thereby preventing the transmission of normal control signals.

The system may store the derived attack paths in the database and may calculate a risk value by comprehensively evaluating, for each path, factors such as attack feasibility, attack difficulty, and the potential level of impact. The calculated risk value and the associated evaluation results may be used as the basis for establishing the security goals and may be used to identify, derive, and prioritize appropriate security control measures and alternative security measures for each attack path.

According to an embodiment of the present invention, the system may derive one or more attack paths based on the impact scenario and may evaluate the attack feasibility and the impact rating for each derived attack path, thereby calculating the final risk value. The calculated risk value may be used for establishing the security goals and selecting security countermeasures according to priority.

The system may evaluate the attack feasibility for each attack path, and the evaluation may be composed of multiple detailed elements. For example, elapsed time may represent the time required to complete the attack, specialist expertise may represent the level of technical proficiency required to perform the attack, knowledge of the item or component may represent the attacker's understanding of the system, protocol, or interface, window of opportunity may represent the temporal or environmental conditions under which the attack is possible, and equipment may represent the physical or software tools required to execute the attack.

The system may assign qualitative or quantitative scores to each of the above elements and may calculate the attack feasibility value through weighted summation, rule-based evaluation, or arithmetic combination. The system may combine the calculated attack feasibility value and the impact rating to derive the risk value for each attack path.

The derived risk value may subsequently be used for prioritizing security countermeasures, establishing security goals, and selecting specific control measures during the design and operational stages. The system may store the attack feasibility value, the impact rating, the risk value, and associated metadata for each attack path in the database and may perform the following subsequent operations based on these stored values.

The system may determine the priority of security countermeasures for each attack path based on the calculated risk value and may recommend appropriate countermeasures or present the results for manual review. The system may also review the consistency between the determined safety level and the security goals and may analyze and resolve potential conflicts between safety requirements and security requirements. In addition, by mapping appropriate security control measures and alternative security measures for each attack path, the system may derive and manage specific response measures for the identified risks.

According to an embodiment of the present invention, the system may establish the security goals of the vehicle based on the derived attack paths and the predicted threat scenario. In an embodiment, the security goals may be established to satisfy the required levels of integrity and availability defined by the safety goals. In addition, during the process of establishing the security goals, the system may not merely identify risks but may also consider the characteristics of each risk and the interdependencies within the vehicle system, thereby defining corresponding security control measures such as access control, encrypted communication, and data integrity verification. The security goals established in this manner may be applied throughout the entire design and operational phases of the vehicle system so that specific attack paths are blocked in advance or, even if a threat is realized, the system may be configured to return to a safe state.

According to an embodiment, based on the security goals, security control measures and alternative security measures required to satisfy the conditions of the safe state may be determined. For identical or similar predicted threat scenario, the results of applying the security control measures and the results of applying the safety mechanisms may be linked to each other and managed in an integrated manner within the database. In addition, the results of such risk evaluation and mitigation may serve as reference information for subsequent tracking and risk reassessment, thereby ensuring the continuous cybersecurity and safety of the system.

As a result, the security goal establishing step according to the present invention may define a cybersecurity goal and/or a cybersecurity assurance level (CAL) for protecting critical assets within the vehicle, based on the analysis results of the attack path and the predicted threat scenario. According to the required level of cybersecurity, appropriate security control measures and alternative mitigation procedures may be derived, thereby enhancing the overall cybersecurity reliability of the vehicle and establishing an integrated risk management framework that combines both safety and cybersecurity.

FIG. 3 is a diagram exemplifying security threat data according to the embodiment of FIG. 2.

Referring to FIG. 3, information and/or data required to establish a security goal for vehicle risk management are illustrated. In FIG. 3, data used to establish the security goal may be referred to as threat data, which may be TARA-specific data. Meanwhile, risk data and threat data, that is, data commonly referenced by both HARA and TARA, may be referred to as common data.

The threat data referenced in TARA may include information regarding a plurality of asset elements. The information regarding the plurality of asset elements may include sub-data concerning the assets, functions of the assets, and properties of the assets. In this case, the data relating to the assets, the functions of the assets, and the properties of the assets may be the common data referenced by both HARA and TARA.

The common data relating to the safety level may correspond to data regarding the ASIL (Automotive Safety Integrity Level). For example, the safety level may be determined based on data relating to the exposure of the hazardous situation, the severity of the hazardous situation, and the controllability of the hazardous situation. Here, the data relating to exposure, severity, and controllability may correspond to hazard data referenced only in HARA. The safety goal may be derived based on the safety level data, which is the common data referenced in both HARA and TARA.

The common data relating to the impact scenario may represent data regarding potential impacts that may be derived from the predicted threat scenarios. Referring to FIG. 3, the data relating to the impact scenario may include sub-data regarding safety elements, operational elements, financial elements, and privacy elements. In other words, the impacts from the expected threats may indicate the level of loss or damage associated with safety, financial aspects, operational aspects, and privacy aspects. The data relating to the impact scenario may also serve as the basis for quantifying, in the event of a threat scenario, the functional, financial, operational, or privacy-related impacts on the vehicle. Here, the data relating to the safety element may correspond to common data that can be derived based on the safety level. The data relating to the operational element, financial element, and privacy element may correspond to threat data referenced only in TARA.

The data relating to the security goal, which is common data, may be derived based on at least one of the common data and the threat data. For example, by analyzing data relating to the predicted threat scenario and the attack path, which are referenced only in TARA, the system may evaluate the influence of the corresponding threat on the assets, functions, or services of the vehicle, and based on the evaluation result, a security goal for ensuring the integrity, availability, confidentiality, and authentication of the vehicle system may be established.

FIG. 4 is a block diagram of a vehicle risk management system according to an embodiment.

Referring to FIG. 4, the server 10 of the vehicle risk management system 1 may include a database 20, a communication unit 110, and/or a controller 120.

The database 20 may store information and/or data required to establish a security goal for vehicle risk management. For example, data used for establishing the security goal may be referred to as threat data. The threat data may be TARA-specific data or data commonly referenced by both TARA and HARA.

The database 20 may store at least some of the preset plurality of threat data required for performing TARA during the vehicle risk-management process. For example, the database 20 may store TARA-exclusive data. The TARA-exclusive data may be composed of a plurality of data items that represent respective sequential steps of a preset TARA procedure. The TARA-exclusive data may also include at least one piece of sub-data.

The database 20 may store a preset plurality of common data that are commonly referenced in both the HARA process and the TARA process. For example, the database 20 may store the common data illustrated in FIGS. 2 and 3, which are referenced in both HARA and TARA.

Meanwhile, at least a portion of the threat data, its subordinate data, and the common data may have a hierarchical structure in which the data items are dependent on or linked with one another, and a modification or update of specific data may be interlocked with the update of other associated data.

The database 20 may store connection-relationship information that defines hierarchical relationships among the TARA-exclusive data, that is, the threat data according to the sequential phases of TARA.

The database 20 may store connection-relationship information that represents the stepwise or hierarchical relationships among the common data commonly referenced in both HARA and TARA.

The database 20 may store information indicating interconnection relationships between the threat data and the common data. For example, the database 20 may store connection relationship information that allows at least one of the TARA-specific data and the data commonly referenced by both TARA and HARA to form a linked or referable hierarchical structure.

The communication unit 110 may establish a communication channel between the server 10 and external devices, for example the first through fifth electronic devices 31, 32, 33, 34, and 35 illustrated in FIG. 1, and may transmit and receive data through the established communication channel. The communication unit 110 may include a communication circuit and a control circuit configured to control the operation of the communication circuit in order to support such communication functions.

For example, the communication unit 110 may include a wireless communication module such as a cellular communication module, a Wi-Fi communication module, a short-range wireless communication module, or a global navigation satellite system communication module, and/or a wired communication module, and may transmit and receive data with external devices through the corresponding module.

The controller 120 may be electrically connected to each component of the server 10, for example the database 20 and the communication unit 110, and may control each component.

The controller 120 may control the database 20 to store TARA-exclusive data and common data of HARA and TARA.

The controller 120 may be communicatively connected to the electronic devices 31, 32, 33, 34, and 45 through the communication unit 110. Although only one first electronic device 31 is illustratively shown in FIG. 4, this is merely for explanation, and the capability to communicate with multiple electronic devices does not limit the scope of the present invention.

The controller 120 may receive a user ID from the first electronic device 31 and may set and assign user permissions for the electronic device 31 based on the received user ID.

The controller 120 may receive evaluation target information corresponding to a vehicle asset or vehicle function from the first electronic device 31 through the communication unit 110.

In response to receiving the evaluation target information, the controller 120 may generate and output TARA result data for the evaluation target information based on the TARA-exclusive data and/or the common data of HARA and TARA.

The controller 120 may generate TARA result data for the evaluation target information, based on user input information (or user data) for at least a portion of the TARA-exclusive data and/or the common data of HARA and TARA received through the communication unit 110. For example, the user input information may include a user-configured value for the corresponding data, that is, a parameter. The controller 120 may generate TARA result data corresponding to the evaluation target information based on a designated template for TARA (for example a dynamic template) stored in the memory 122. The generated TARA result data may be transmitted to the first electronic device 31 through the communication unit 110.

The controller 120 may identify data among the TARA result data that is preset to be included in an FSM document, and may generate FSM document data based on a designated FSM template (for example a dynamic template) stored in the memory 122, and may output the generated FSM document data. The generated FSM document data may also be transmitted to the electronic device 31 through the communication unit 110.

The controller 120 may include a control circuit configured to control the performance of the above functions.

The controller 120 may be implemented as a micro control unit (MCU) and may include the memory 122 and a processor 121.

The memory 122 may store programs and/or data for processing each piece of data (for example data received from external devices such as the first through fifth electronic devices 31, 32, 33, 34, and 35 shown in FIG. 1).

The memory 122 may temporarily store each piece of data or may temporarily store the processing result of data processed by the processor 121.

The memory 122 may include volatile memory such as S-RAM or D-RAM as well as non-volatile memory such as flash memory, ROM, EPROM, and/or EEPROM.

The processor 121 may process each piece of received data and may output signals for controlling the communication unit 110 and/or the database 20 based on the processing result.

The first electronic device 31 may include a communication unit 310, an input unit 320, an output unit 330, and a controller 340.

The communication unit 310 may establish a communication channel between the first electronic device 31 and an external device, for example the server 10, and may transmit and receive data through the established communication channel. The communication unit 310 may include a communication circuit and a control circuit configured to control operation of the communication circuit.

For example, the communication unit 310 may include a wireless communication module such as a cellular communication module, a Wi-Fi communication module, a short-range wireless communication module, or a global navigation satellite system communication module, and/or a wired communication module, and may transmit and receive data with an external device through the corresponding communication module.

The input unit 320 may receive information according to a user operation and may provide the information to a connected device such as the controller 340.

For example, the input unit 320 may include input means such as buttons, switches, a touchscreen, and/or a microphone.

The output unit 330 may output visual and/or auditory information so that a user of the first electronic device 31 can perceive the information. For example, the output unit 330 may include a display and/or a speaker.

The controller 340 may be electrically connected to each component of the first electronic device 31, for example the communication unit 310, the input unit 320, and/or the output unit 330, and may control operations of the respective components.

The controller 340 may communicate with the server 10 through the communication unit 310. The controller 340 may receive a service for management of TARA documents from the server 10 through the communication unit 310.

For example, the controller 340 may receive at least a portion of the TARA-exclusive data, and/or the common data of HARA and TARA from the server 10, and may output the received data through the output unit 330, for example a display.

The controller 340 may acquire evaluation target information corresponding to a vehicle asset or function according to a user operation through the input unit 320.

The controller 340 may acquire user input information, for example a parameter, through the input unit 320 for at least a portion of the TARA-exclusive data, and/or the common data of HARA and TARA.

The controller 340 may transmit the user input information acquired through the input unit 320 to the server 10 through the communication unit 310 for at least a portion of the TARA-exclusive data, and/or the common data of HARA and TARA.

The controller 340 may receive TARA result data for the evaluation target information from the server 10 through the communication unit 310, and may output the received result data to the user through the output unit 330, for example a display.

In addition, the controller 340 may receive result data for the FSM document from the server 10 through the communication unit 310 and may output the data through the output unit 330, for example a display.

Meanwhile, the controller 340 may include a control circuit.

The controller 340 may be implemented as a micro control unit (MCU; Micro Control Unit) and may include a memory 342 and/or a processor 341.

The memory 342 may store programs and/or data for processing each piece of data, for example data received from an external device such as the server 10 or data corresponding to information input through the input unit 320.

The memory 342 may temporarily store received data or may temporarily store results of data processed by the processor 341.

The memory 342 may include volatile memory such as S RAM and/or D RAM, and non volatile memory such as flash memory, ROM (Read Only Memory), EPROM (Erasable Programmable Read Only Memory), and/or EEPROM (Electrically Erasable Programmable Read Only Memory).

The processor 341 may process each received or input piece of data and may provide control signals to the respective components in order to control the communication unit 310, the input unit 320, and the output unit 330 based on the processing result.

Although not shown in FIG. 4, the second electronic device 32, the third electronic device 33, the fourth electronic device 34, and the fifth electronic device 35 of FIG. 1 may include a communication unit, an input unit, an output unit, and a controller similar to those of the first electronic device 31, and may perform operations similar to those of the first electronic device 31.

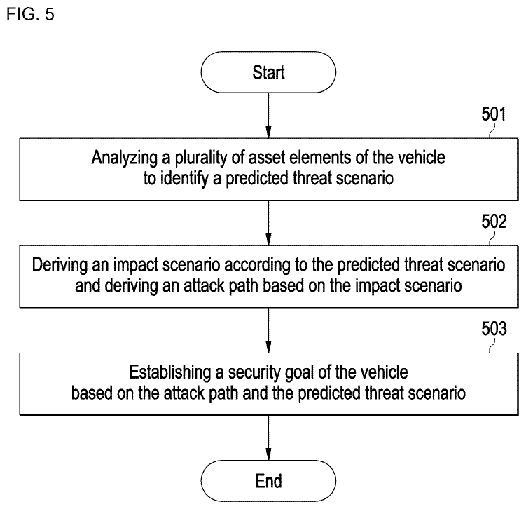

FIG. 5 is a flowchart illustrating a control operation procedure of a server according to an embodiment.

Referring to FIG. 5, the server may analyze a plurality of asset elements of the vehicle and identify a predicted threat scenario (501).

According to an embodiment, the plurality of asset elements may be TARA related data concerning cybersecurity and may include an asset to be protected, a function of the asset, and a property of the asset. Here, the data regarding the asset, the function of the asset, and the property of the asset may be data commonly referenced by both HARA and TARA.

An asset may be a physical or logical component within the system that needs to be protected and may be information such as vehicle diagnostic data or control signals. The function of the asset may be an operation performed by the asset or a service provided by the asset, for example reading or writing vehicle diagnostic data. The property of the asset may be characteristic information such as the communication interface to which the asset belongs, the transmission direction of the data, or the access permission level. The function of the asset may correspond to the vehicle function, and a safety hazard caused by a malfunction of the vehicle function may correspond to a security risk caused by a compromise of the function of the asset.

The server may derive an impact scenario corresponding to the predicted threat scenario and derive an attack path based on the impact scenario (502).

According to an embodiment, the impact scenario may be generated by deriving a damage scenario corresponding to the plurality of asset elements and simulating the effect of the damage scenario on the driver or the vehicle. The impact scenario may represent data that quantitatively or qualitatively expresses the effect on the overall system, vehicle functions, the driver, or the external environment when a specific risk or threat actually occurs. The impact scenario may also be used as common data linking the results of hazard analysis (HARA) and security analysis (TARA).

According to an embodiment, the attack path may be generated based on at least one of a safety element, a financial element, an operational element, and a privacy element for the impact scenario. Here, the safety element may be derived from a safety level.

The safety level may be determined by evaluating the exposure, severity, and controllability of the hazard situation according to a predetermined evaluation criterion and by combining the evaluation results of the exposure, severity, and controllability. Specifically, the server may analyze data included in the impact scenario, identify how a particular threat may infiltrate and propagate within the vehicle system, and derive a corresponding attack path.

The server may establish a security goal of the vehicle based on the attack path and the predicted threat scenario (503).

According to an embodiment, the security goal may be generated based on a risk value for the attack path and the predicted threat scenario. For the process of generating the security goal, reference may be made to the description of FIG. 2 above. According to an embodiment, based on the security goal, security control measures and alternative security measures for satisfying the conditions of a safe state may be determined.

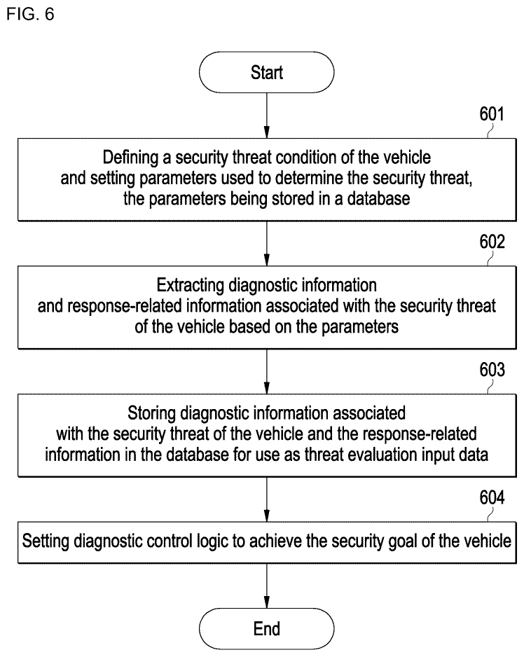

FIG. 6 is a flowchart illustrating a control procedure of a server for achieving a security goal of a vehicle according to an embodiment.

Referring to FIG. 6, the server may define security threat conditions of the vehicle and set parameters used to determine the security threat, and store the parameters in the database (601). For example, the server may set various security diagnostic data as parameters, such as abnormal communication patterns, variations in message cycles, authentication errors, abnormal access attempts, communication delays, and packet loss rates, and may determine whether a potential security threat has occurred based on the parameters.

The server may extract diagnostic information and response-related information associated with the security threat of the vehicle based on the parameters used to determine the security threat (602). The server may construct a threat detection logic by referring to threshold values of the parameters, normal communication characteristics, and abnormal-event occurrence conditions, and define response steps to be applied when a threat occurs, such as generating warnings, blocking messages, restricting privileges, or switching to a protection mode. Through this, the server may extract reference information required for managing cybersecurity threats of the vehicle.

The server may store diagnostic information and response-related information associated with the vehicle's security threat in the database and use the information as threat-assessment input data (603). The server may structure and store in the database various types of analytical data, such as threat-detection results, threat occurrence times, occurrence frequency or number of attempts, system-state changes, applied response measures, and their effectiveness, obtained through the diagnostic procedure defined in step 602. Through this, the server may enable the stored analytical data to serve as reliable evidence in the risk-assessment process related to vehicle cybersecurity. That is, information such as the cause of each threat, attack techniques, likelihood of successful attack, and effectiveness of defensive measures may be reflected in the risk assessment for each threat scenario during a subsequent TARA analysis.

The server may set diagnostic control logic for achieving the security goal of the vehicle (604). The server may construct diagnostic control logic that includes threat-detection criteria, anomalous-behavior determination rules, and response policies corresponding to the security goal, and may deploy or update the logic in association with a vehicle controller or a network gateway. In addition, the server may improve the vehicle system's capability to respond to security threats by automatically adjusting or supplementing parameters of the configured logic based on real-time security monitoring data and communication logs collected from the vehicle.

According to an embodiment, for identical or similar predicted threat scenarios, the server may match the application results of the diagnostic control logic and manage them integratively within the database.

Meanwhile, the embodiments described above present a unified framework that allows risk-management activities to be performed without missing information. The framework eliminates resource waste and redundancy that may occur during the execution and management of cybersecurity activities. This framework was validated through an example involving a vehicle braking system, demonstrating improved efficiency of cybersecurity management procedures. In particular, the embodiment shown in FIG. 6 provides a foundation for establishing optimization strategies for cybersecurity management throughout the vehicle life cycle through a recursive analysis beginning with the item definition. The utilization of this framework is expected to reduce development costs, lower quality-related costs through quality improvement, and ultimately contribute to improved productivity and enhanced sustainability of the enterprise.

In addition, in the above-described embodiments, emphasis was placed on identifying relationships among the TARA data and unifying risk-mitigation activities through the newly identified cybersecurity controls and safety mechanisms. However, the quality of the risk-mitigation results may depend on the level of detail in the design and analysis. Therefore, tools such as fault tree analysis, attack path analysis, and failure mode and effects analysis may be further expanded as part of the framework for managing cybersecurity in the above-described embodiments.

In another aspect, the disclosed embodiments may be implemented in the form of a recording medium storing instructions that are executable by a computer. The instructions may be stored as program code and, when executed by a processor, may generate program modules that perform the operations of the disclosed embodiments. The recording medium may be implemented as a computer-readable recording medium.

The computer-readable recording medium includes any type of medium in which instructions that can be interpreted by a computer are stored. Examples include read only memory (ROM), random access memory (RAM), magnetic tapes, magnetic disks, flash memory, and optical data storage devices.

The machine-readable storage medium may be provided as a non-transitory storage medium. The term “non-transitory” merely indicates that the storage medium is a tangible device that does not include signals such as electromagnetic waves, and does not distinguish whether data is stored permanently or temporarily. For example, a non-transitory storage medium may include a buffer in which data is stored temporarily.

The disclosed embodiments have been described above with reference to the accompanying drawings. It will be understood by those skilled in the art that various modifications and other embodiments may be made without departing from the technical spirit or essential characteristics of the present invention. The disclosed embodiments are therefore to be regarded as illustrative and not restrictive.

1. A vehicle risk management method comprising:
analyzing a plurality of asset elements of the vehicle to identify a predicted threat scenario;
deriving an impact scenario according to the predicted threat scenario and deriving an attack path based on the impact scenario; and
establishing a security goal of the vehicle based on the attack path and the predicted threat scenario.

2. The method of claim 1,
wherein the plurality of asset elements include an asset to be protected, a function of the asset, and a property of the asset, and
wherein the function of the asset corresponds to a function of the vehicle, and a safety hazard caused by a malfunction of the function of the vehicle corresponds to a security risk caused by a compromise of the function of the asset.

3. The method of claim 2,
wherein the impact scenario is generated by deriving a damage scenario according to the plurality of asset elements and simulating an influence of the damage scenario on a driver or the vehicle.

4. The method of claim 1,
wherein the attack path is determined based on an impact rating determined according to at least one of a safety element, a financial element, an operational element, and a privacy element for the impact scenario.

5. The method of claim 4,
wherein the safety element is derived from a safety level, and the safety level is determined by evaluating exposure, severity, and controllability of the hazard situation according to a predetermined evaluation criterion and combining the evaluation results of the exposure, the severity, and the controllability.

6. The method of claim 1,
wherein the security goal is generated based on a risk value according to the attack path and the predicted threat scenario.

7. The method of claim 1,
wherein, based on the security goal, a security control measure and an alternative security measure for satisfying a condition of a safe state are determined.

8. The method of claim 1,
further comprising setting diagnostic control logic to achieve the security goal of the vehicle,
wherein setting the diagnostic control logic comprises:
defining a security threat condition of the vehicle and setting parameters used to determine the security threat, the parameters being stored in a database, and
deriving diagnostic information and response-related information associated with the security threat of the vehicle based on the parameters, and storing the diagnostic information and the response-related information in the database for use as threat evaluation input data.

9. The method of claim 8,
wherein, for the same or similar predicted threat scenario, results of applying the diagnostic control logic are matched with each other to be linked or managed in the database.

10. A computer program stored in a medium for causing a computing device to execute the method according to claim 1.

11. A database configured to store a plurality of data for vehicle risk management;
a communication module configured to communicate with an external device; and
a processor electrically or communicatively connected to the database and the communication module,
wherein the processor is configured to:
analyze a plurality of asset elements of the vehicle to identify a predicted threat scenario,
derive an impact scenario according to the predicted threat scenario and derive an attack path based on the impact scenario, and
establish a security goal of the vehicle based on the attack path and the predicted threat scenario.

12. The server of claim 11,
wherein the plurality of asset elements include an asset to be protected, a function of the asset, and a property of the asset, and
wherein the function of the asset corresponds to a function of the vehicle, and a safety hazard caused by a malfunction of the function of the vehicle corresponds to a security risk caused by the compromise of the function of the asset.

13. The server of claim 12,
wherein the impact scenario is generated by deriving a damage scenario according to the plurality of asset elements and simulating an influence of the damage scenario on a driver or the vehicle.

14. The server of claim 11,
wherein the attack path is determined according to an impact rating determined based on at least one of a safety element, a financial element, an operational element, and a privacy element for the impact scenario.

15. The server of claim 14,
wherein the safety element is derived from a safety level, and the safety level is determined by evaluating exposure, severity, and controllability of a hazard situation according to predetermined assessment criteria and combining results of the evaluation of the exposure, the severity, and the controllability.

16. The server of claim 11,
wherein the security goal is generated based on a risk value according to the attack path and the predicted threat scenario.

17. The server of claim 11,
wherein the processor is configured to determine security control measures and alternative security measures to satisfy a condition of a safe state based on the security goal.

18. The server of claim 11,
wherein the processor is configured to:
set diagnostic control logic to achieve the security goal of the vehicle, define a security threat condition of the vehicle,
set parameters used to determine the security threat, and store the parameters in the database, and
derive diagnostic information and response-related information associated with the security threat of the vehicle based on the parameters and store the diagnostic information and the response-related information in the database for use as threat evaluation input data, thereby setting the diagnostic control logic.

19. The server of claim 18,
wherein the processor is configured such that, for the same or similar predicted threat scenarios, results of applying the diagnostic control logic are matched with each other to be linked or managed in the database.
